(19) United States
(12) Patent Application Publication
(10) Pub. No.: US 2004/0170033 A1
(43) Pub. Date: Sep. 2, 2004

(54) Circuit for conversion DC to AC with voltage elevation and noise reduction

(76) Inventor: Jacky Peng, Taipei (TW)

Correspondence Address: Jacky Peng, PO Box 82-144, Taipei, TW

(21) Appl. No.: 10/374,424

(22) Filed: Feb. 27, 2003

(51) Int. Cl. H02M 1/12

(52) U.S. Cl. 363/44

(57) ABSTRACT

Circuit for conversion DC to AC with voltage elevation and noise reduction is disclosed. The circuit comprises transistors, sensors, capacitors connected in series to form a low voltage elevated to high voltage portion, and a plurality of transistors and capacitors to form AC electronic switching portion, characterized in that signals controlling action of the transistors are upgraded from low potential to high potential to speed out the action of the transistor, and at cut off, the signal is formed into negative level configuration, or higher than the positive potential level configuration for circuit action, thereby effective signals on the load is obtained.

### BACKGROUND OF THE INVENTION

(a) Technical Field of the Invention

The present invention relates to circuit for conversion of DC to AC, and in particular, a circuit which can effectively elevate output voltage.

(b) Description of the Prior Art

Conventional electro luminescent, such as disclosed in Taiwanese Patent No. 117663, as shown in FIG. 1, relates a full wave AC voltage elevation circuit. In the figure, the left of the dotted line is high voltage elevated from low voltage portion, and the right of the dotted line forms the switching portion of AC. At point H, a high voltage signal is formed but after the switching portion, the high voltage at H will alternate about 10-30% due to inherit voltage problem of electronic parts. As a result, the efficiency of the conversion is greatly affected.

Taiwanese Patent No. 117663 relates to circuit of electro luminescent which is shown in FIG. 3, and Taiwanese patent application no. 090202291 relates to circuit structure of electro luminescent, which is shown in FIG. 4. As shown in FIG. 5, the concept of the control of signal wave portion is similar. If the control signal of A and B are modified to the configuration of FIG. 6, the efficiency is increased to about 20-30% above.

It is an object of the present invention to provide a circuit for conversion of DC to AC which can effectively elevate output voltage.

### SUMMARY OF THE INVENTION

Accordingly, it is an object of the present invention to provide a circuit for conversion of DC to AC with voltage elevation and noise reduction comprising transistors, sensors, capacitors connected in series to form a low voltage elevated to high voltage portion, and a plurality of transistors and capacitors to form AC electronic switching portion, characterized in that signals controlling action of the transistors are upgraded from low potential to high potential to speed out the action of the transistor, and at cut off, the signal is formed into negative level configuration, or higher than the positive potential level configuration for circuit action, thereby effective signals on the load is obtained.

Another object of the present invention is to provide a circuit for conversion DC to AC with voltage elevation and noise reduction, wherein a plurality of diodes are used to replace the electronic switching portions to produce in sequence high voltage at the two ends of capacitance load, forming a high voltage AC signal.

Still another object of the present invention is to provide a circuit for conversion DC to AC with voltage elevation and noise reduction, wherein capacitors and transistors are incorporated to the circuit to change the output wave form of the control signal, lowering noise generated in the course of DC to AC conversion.

A further object of the present invention is to provide a circuit for conversion DC to AC with voltage elevation and noise reduction, wherein fixed current of the circuit is controlled so as to control the current releasing time so as to lower the noise generated in the course of DC to AC conversion.

Another further object of the present invention is to provide a circuit for conversion DC to AC with voltage elevation and noise reduction, wherein at period between the voltage elevation to the end of the voltage elevation, the control signal frequency width is changed so as to increase the smoothness of output wave form.

Still another object of the present invention is to provide a circuit for conversion DC to AC with voltage elevation and noise reduction, wherein the circuit is incorporated with a full bridge switch to maintain high voltage AC to independently control a plurality of EL so as to lower noise generated in the course of DC to AC.

The foregoing object and summary provide only a brief introduction to the present invention. To fully appreciate these and other objects of the present invention as well as the invention itself, all of which will become apparent to those skilled in the art, the following detailed description of the

invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a circuit diagram of a conventional full wave voltage elevation.

FIG. 2 is a circuit diagram of a conventional half wave voltage elevation.

FIG. 3 shows circuits of another conventional full wave voltage elevation and a partial switching structure.

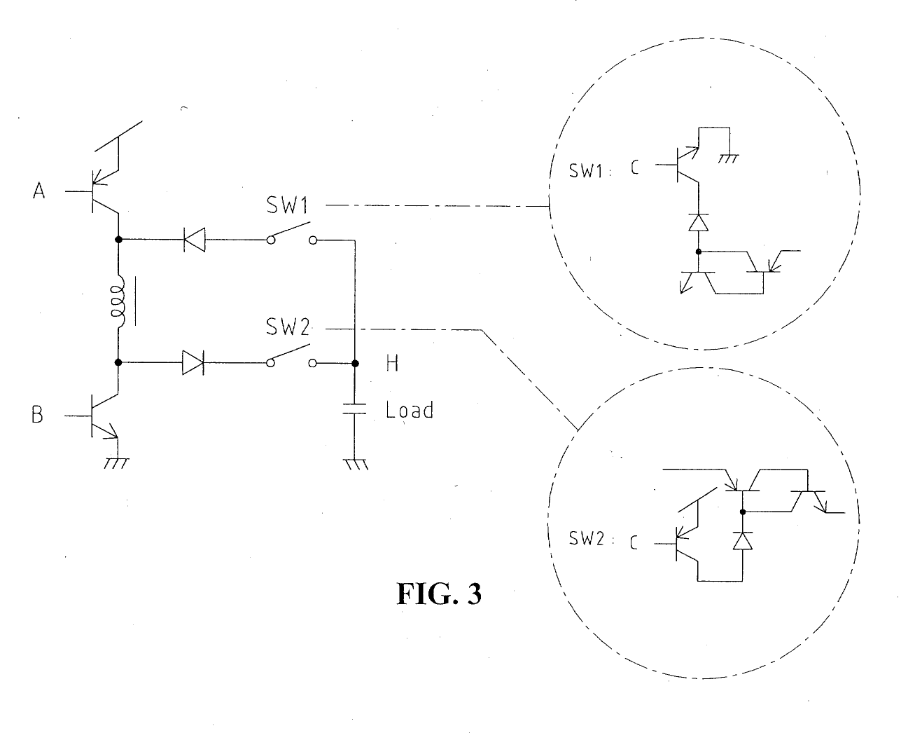

FIG. 4 is a circuit diagram of another conventional full wave voltage elevation.

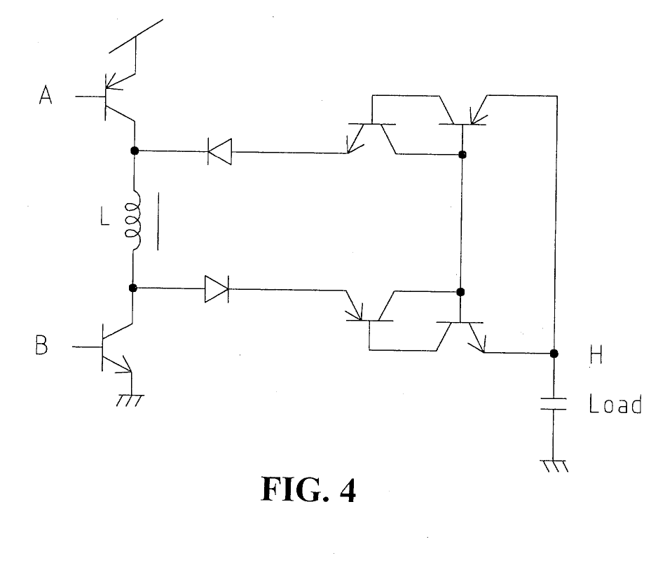

FIG. 5 is a schematic view of a control signal wave form of FIG. 3.

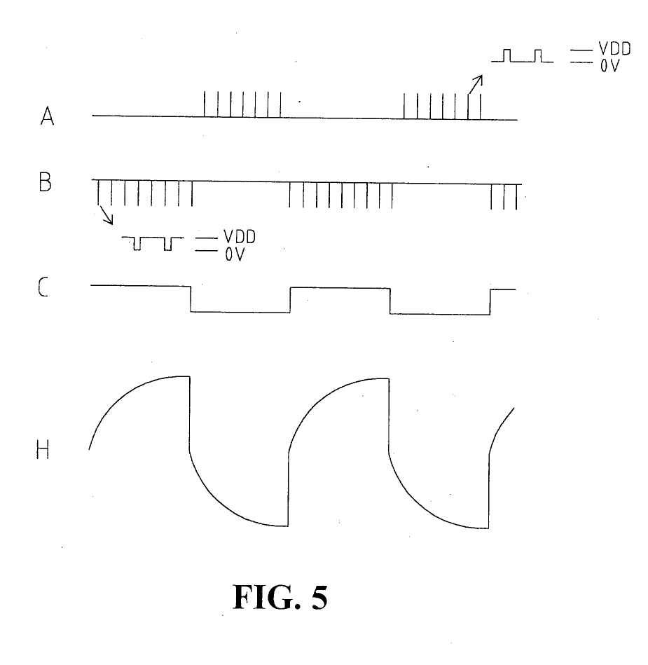

FIG. 6 is a schematic view of another control signal wave form of FIG. 3.

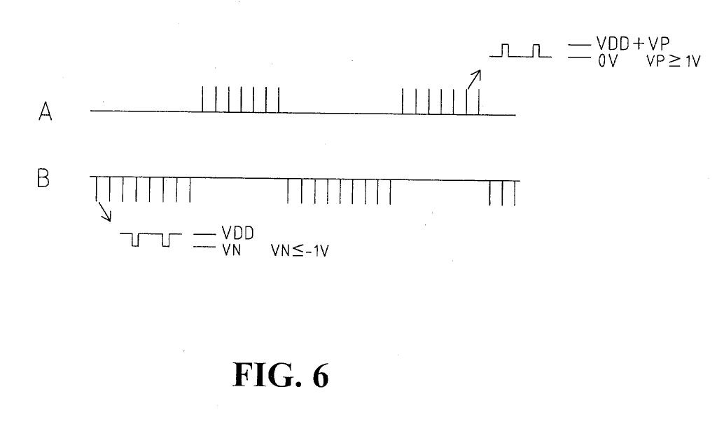

FIG. 7 shows a preferred embodiment of the present invention.

FIG. 8 shows a control signal-wave form of FIG. 7.

FIG. 9 shows another preferred embodiment of the present invention.

FIG. 10 is a control signal wave form of FIG. 9.

FIG. 11 is a wave form of a conventional loaded high voltage AC signal.

FIG. 12 is a wave form of another conventional loaded high voltage AC signal.

FIG. 13 is a wave form of still another conventional loaded high voltage AC signal.

FIG. 14 is a preferred application diagram of the present invention.

FIG. 15 shows control signal and output wave form of FIG. 14.

FIG. 16 is a wave form employing that of FIG. 2.

FIG. 17 is another wave form employing that of FIG. 2.

FIG. 18 is a preferred circuit of the present invention.

FIG. 19 is a conventional control circuit.

FIG. 20 is a schematic diagram of another loaded driving high voltage AC signal wave form.

FIG. 21 is a wave form employing that of FIG. 8.

FIG. 22 is a wave form employing that of FIG. 10.

FIG. 23 is a schematic diagram of another loaded driving high voltage AC signal wave form.

FIG. 24 is a circuit diagram of another preferred embodiment of the present invention.

FIG. 25 is a switching diagram of a conventional full wave voltage elevation.

FIG. 26 is a control signal wave form of FIG. 25.

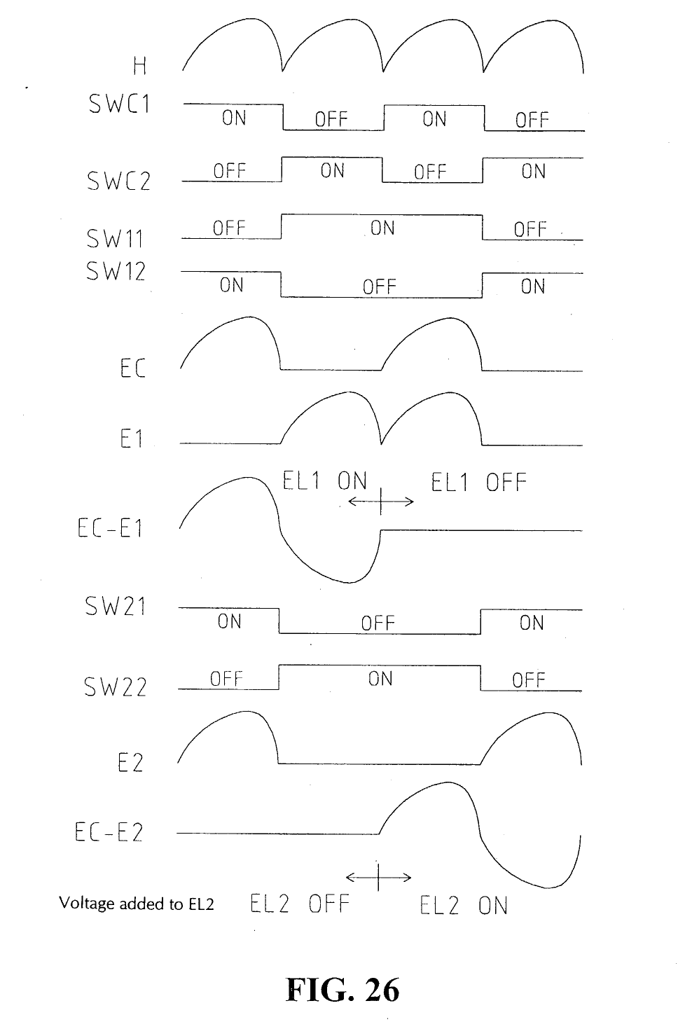

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

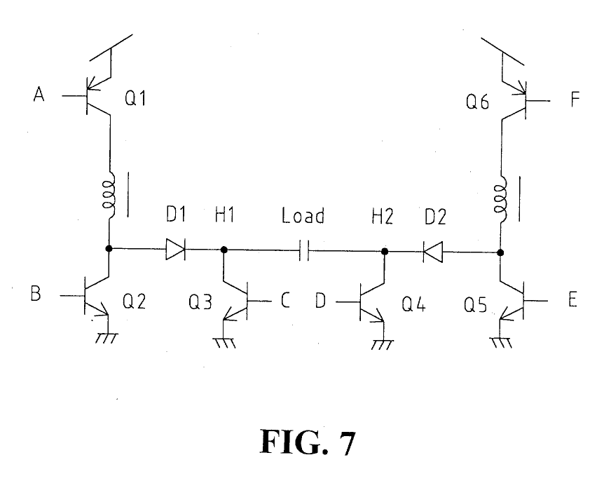

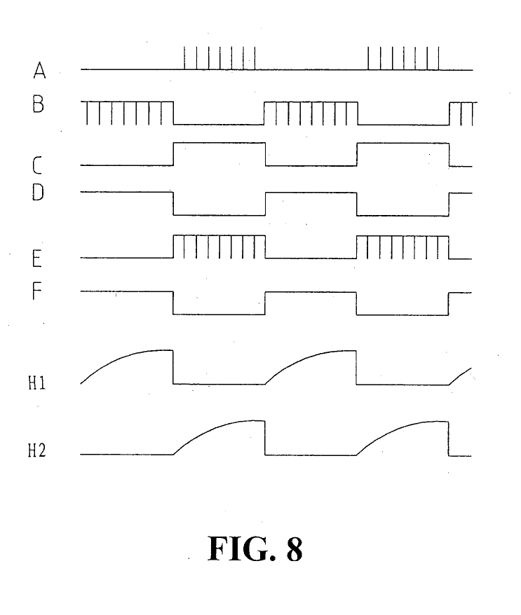

Referring to FIG. 7, there is shown a preferred embodiment of the present invention. The circuit comprises a plurality of transistors Q1-Q5, a plurality of diodes D1, D2 and in combination with sensors and capacitors electronic components. The capacitance load is provided with voltage elevation circuit. When the left side is in action, Q4 of the transistor is in conduction, Q5 is closed, Q1 is in conduction, Q3 is closed, the control signal B of Q2 (refer to FIG. 8) via a period of time, H1 is at a high voltage. At this instance Q2 will stop action, Q1 is closed, Q3 is in conduction, H1 from high voltage is lowered to approximately zero potential via the discharging of Q3, transistor Q4 is closed, Q6 is in communication, Q5 is in action based on E signal via a period of time, H2 will reach a high potential, after that, Q4 is in conduction, Q6 is closed, Q5 stops action, H2 is lowered to approximately zero potential form high potential by discharging of changes. Thus, by repeating, the two ends of the capacitance load generated high voltage in sequence to form into a high voltage AC signal. The advantage of this is to provide efficiency to the signal of the load.

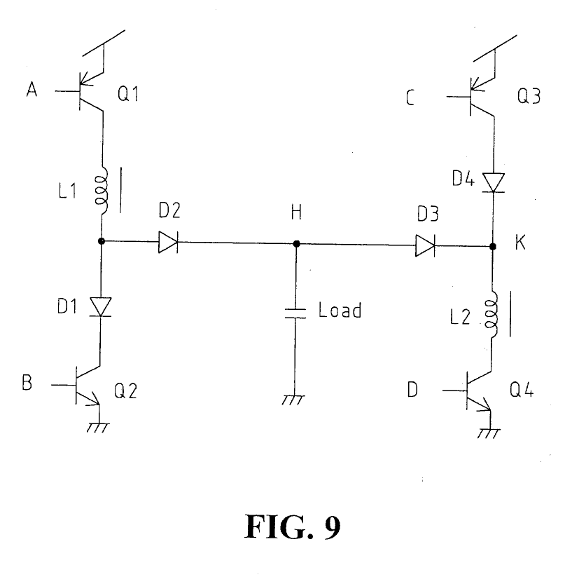

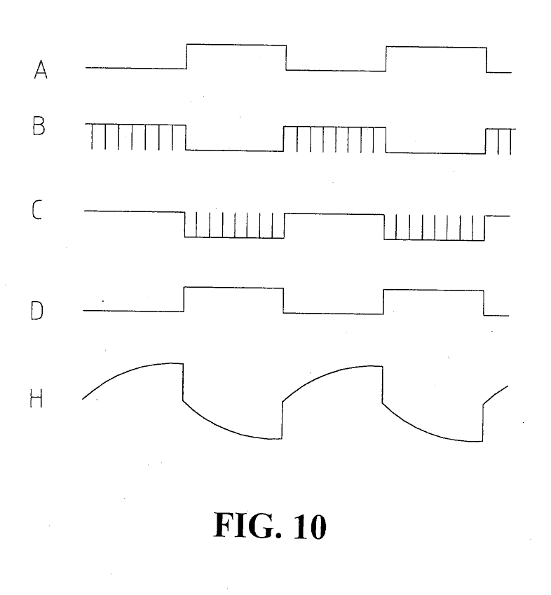

As shown in FIG. 9, there is shown another circuit structure. When Q3, Q4 are OFF, Q1 is in conduction, Q2 is in action based on B control signal of FIG. 10. After a period of time, H reaches to the highest point, Q1, Q2 are closed, Q4 is in conduction, Q3 is in action based on the C control signal. H is at approximately zero potential form a high voltage by discharging via D3, L2, Q4. Due to the elevation of negative voltage of L2 and Q3, after a period of time, H is at a negative high voltage. At this point, Q3, Q4 are OFF, Q1 is in conduction, Q2 is in action, H is at zero potential from a high voltage and then by high voltage changing. Thus, the cycle produces a continuous high voltage AC signal, as shown in FIG. 10.

The application of D1, D4, is to prevent breakdown of transistor. Based on D4 when Q1, Q2 are in action, when Q3, Q4 are OFF, H is provided with a positive voltage signal, k is also provided with a positive voltage signal, and at this instance, Q4 is at OFF. Due to the fact that Q4 is a NPN transistor, the C terminal of Q4 can withstand a positive voltage to a certain extent without breakdown. But Q3 is PNP transistor, C terminal cannot withstand positive voltage signal and therefore, a D4 diode is added to prevent the breakdown of Q3 and the ineffective of the high voltage. Similarly, D1 is added for the reason that Q2 cannot withstand the high voltage. In addition, based on FIG. 7 and FIG. 9, the control signal potential is changed to negative voltage or greater than the positive voltage of VDD, the entire efficiency is increased.

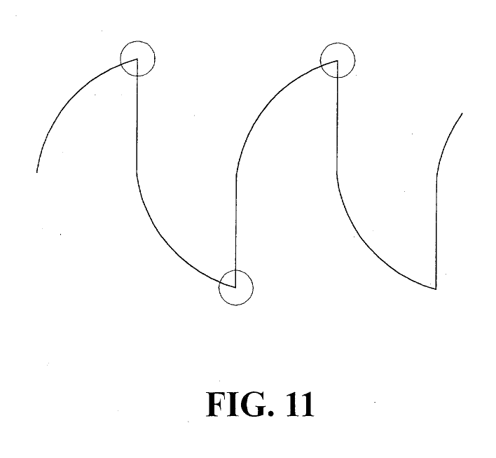

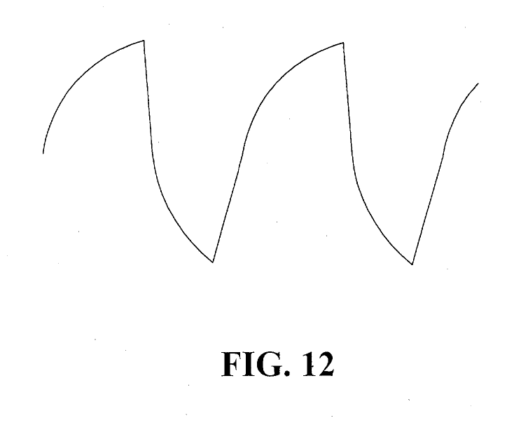

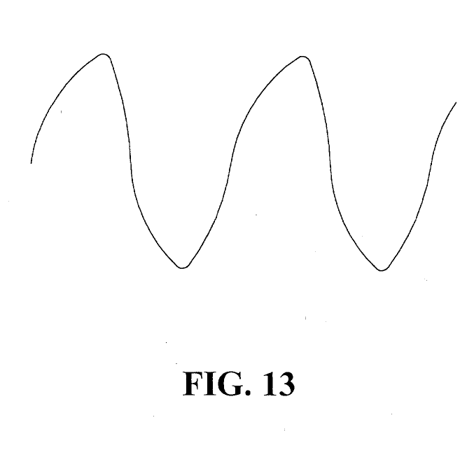

No matter which of the circuit structure is used, the low voltage signal of DC voltage elevation is increased to high voltage AC signal. The only problem to the user for this structure is interference. Generally, this driving structure is used together with other IC or electronic components and distortion is generated. Referring to FIG. 11, the ideal wave is sinusoidal wave and wave form of FIG. 11 can be modified to that of FIGS. 12 or 13.

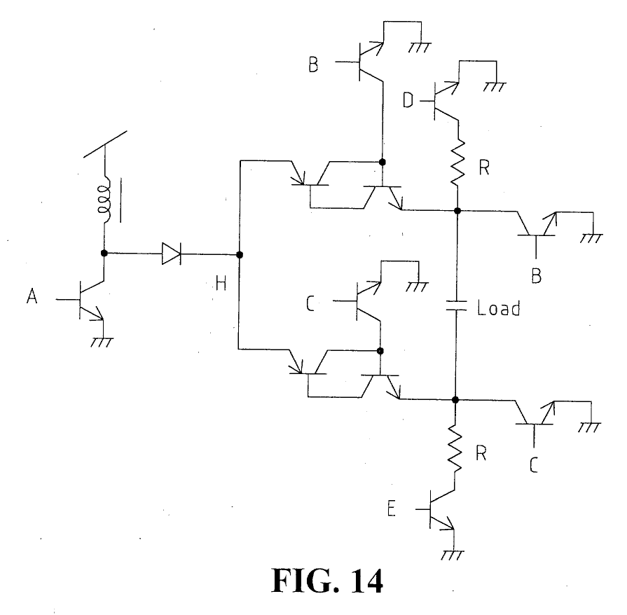

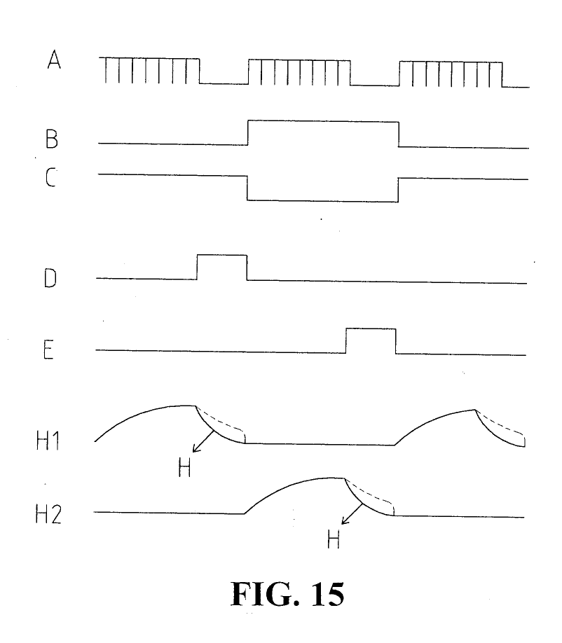

Circuit structure of FIG. can be modified based on FIG. 14 by adding two resistances and two transistors and wave form of FIG. 12 is obtained. The control signal and output wave form are shown in FIG. 15.

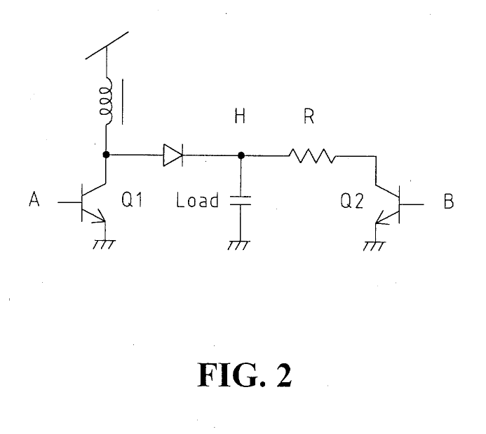

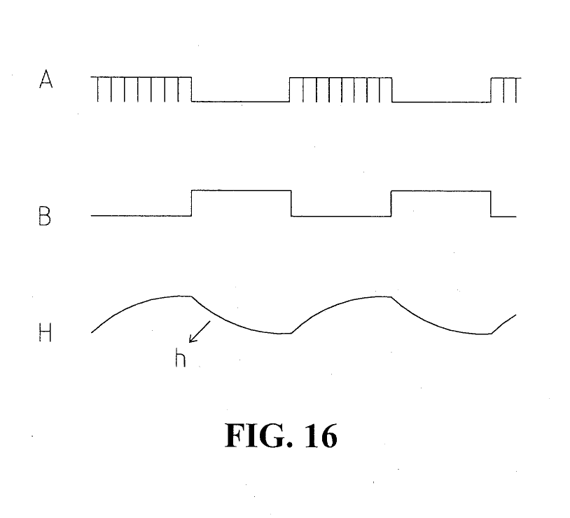

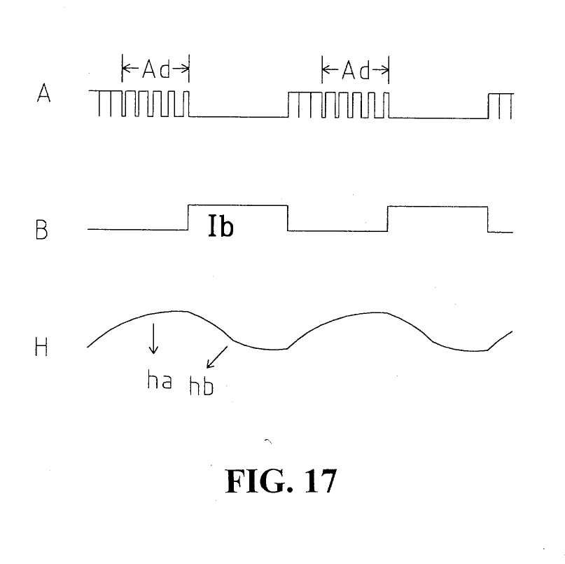

In view of FIG. 2, R is limited when current is released and the wave form is shown in FIG. 16. The value of R determines the slope of H. This is better than the concept where R is zero, however, this is not perfect. The ideal method is let R being zero, and B signal of FIG. 2 or B and C control signal of FIG. 14 to control current and in combination with A signal frequency width, the effect of FIG. 17 is obtained. Due to the change of frequency width of Ad, Ha becomes smoother, and 1b is controlled with respect to current release and Hb wave form is obtained. Let h wave form to close to sinusoidal wave, the interference and noise of capacitance load such as electron luminescent are reduced.

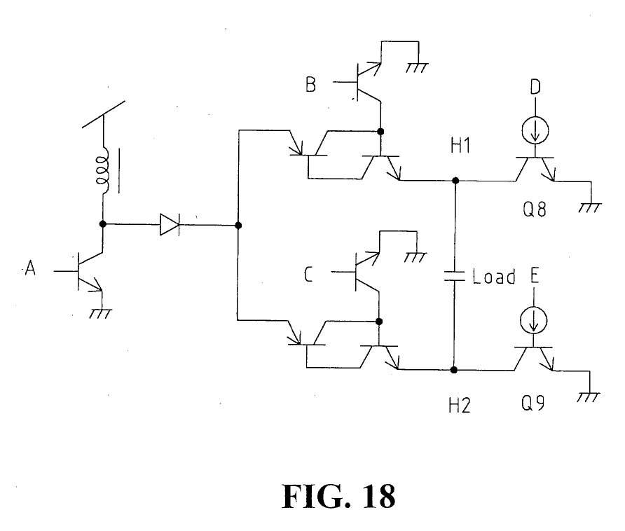

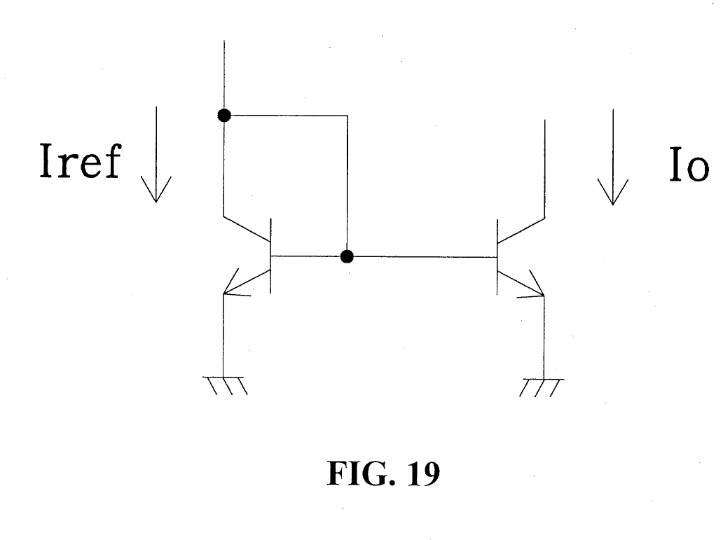

As shown in FIG. 18, there is shown the direct change of current of the control signal. When C=H (high voltage), E=H, H2 is equal to ground, and when B=L (low potential), D=L, H1 is at high voltage after a period of time. At this instance, A does not deliver signal and theoretically H1 is maintained at a high voltage. At this instance, D provides a stable and fixed current, QB is at a high impedance, A1 discharges current slowly and wave form of 12 is obtained. There are a lot of methods to control the fixed current. FIG. 19 is a popular method which can control Q8 or Q9 of FIG. 18. Further, if the current discharging time is controlled and is not fixed but changed slowly with time, or control current discharging via Q8 or Q9 and is changed slowly, the ideal wave form of FIG. 13 is obtained.

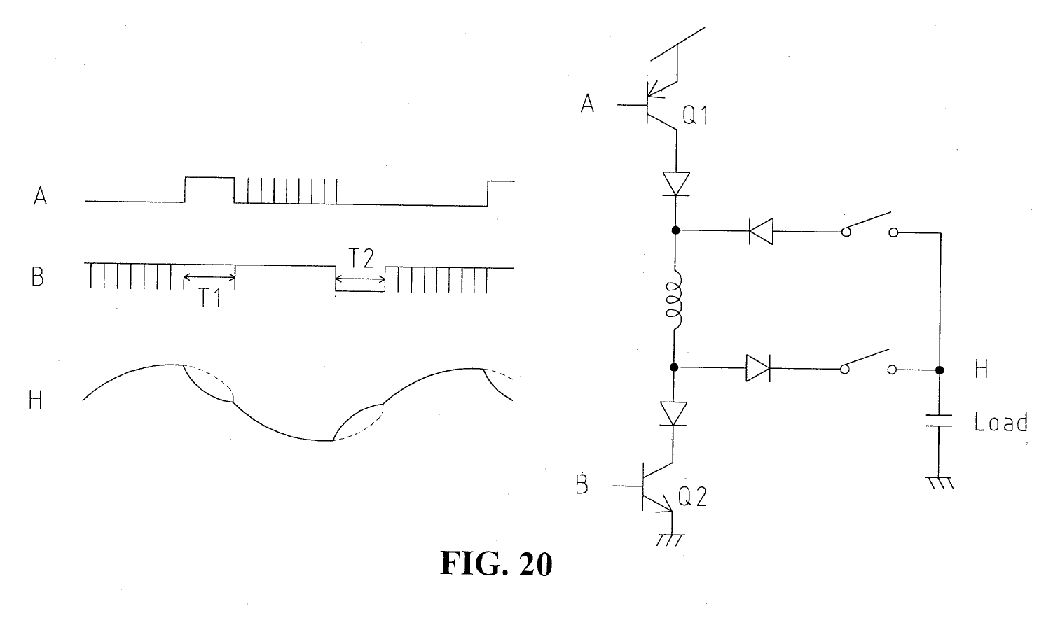

Referring to FIG. 20, there is shown a control signal modified to reduce interference. T1 is B signal being a fixed small current and Q2 is high impedance, and T2 is A signal being fixed small current and Q1 is high impedance.

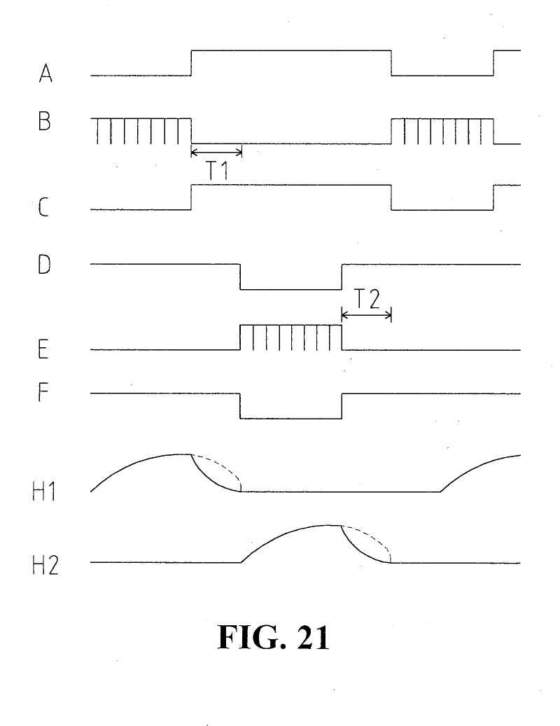

The signal wave form of FIG. 8 is changed to FIG. 21, wherein T1 represents Q3 of FIG. 7 being high impedance, T2 represents Q4 of FIG. 7 being high impedance.

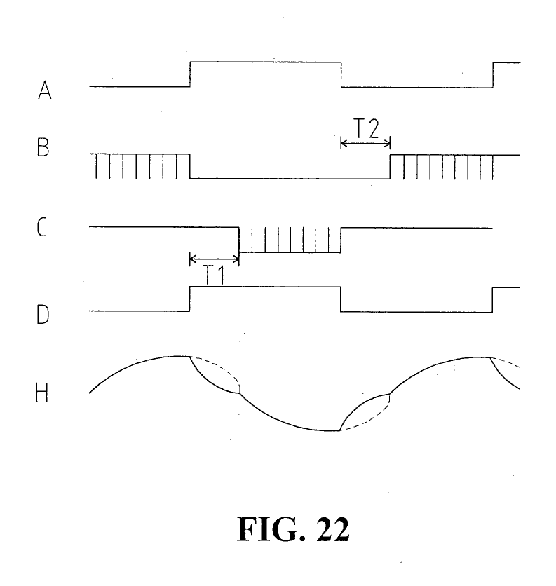

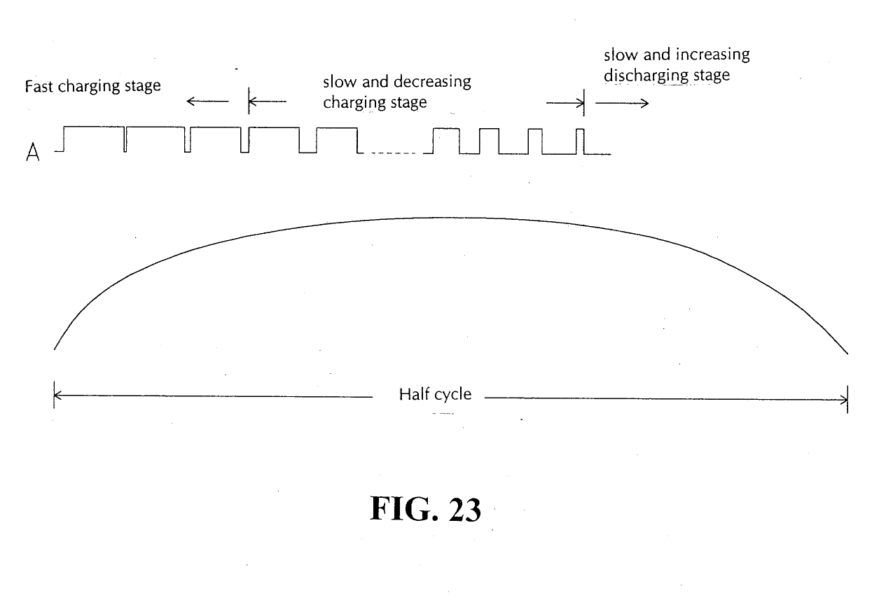

FIG. 10 is modified to FIG. 22 of which the signal wave form can reduce noise, wherein T1 represents Q4 of FIG. 9 being high impedance, T2 represents Q4 of FIG. 9 being high impedance. Further, the voltage elevation control signal is changed and the output wave B closes to sinusoidal wave, as shown in FIG. 23.

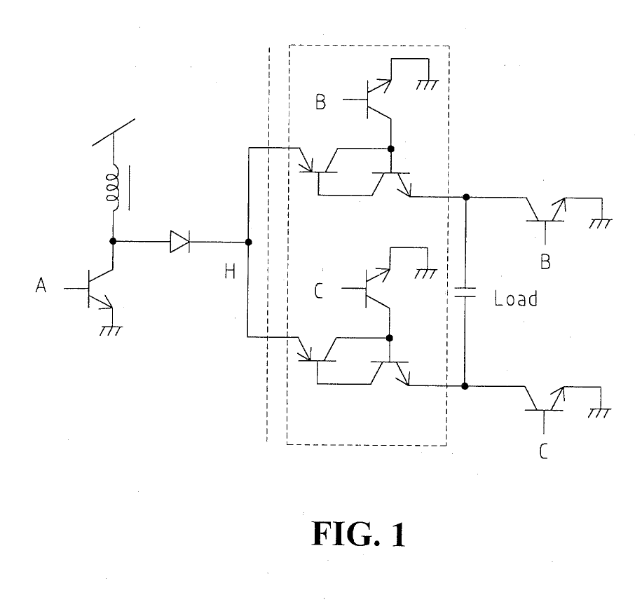

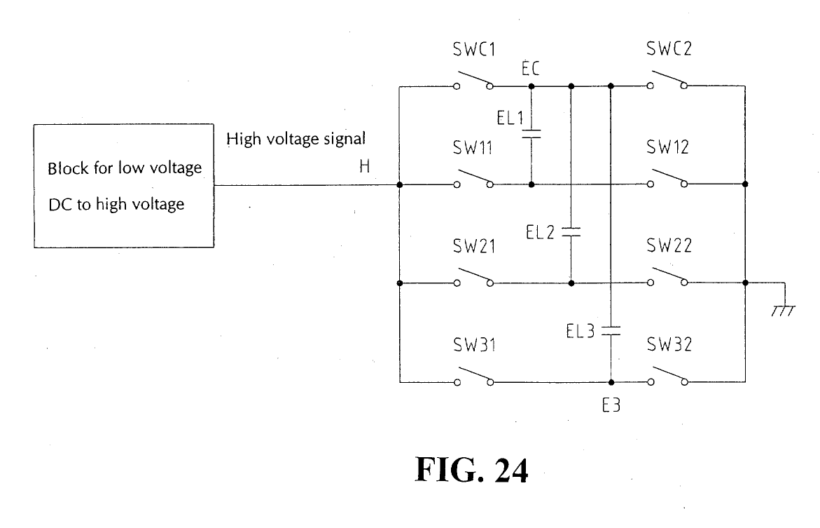

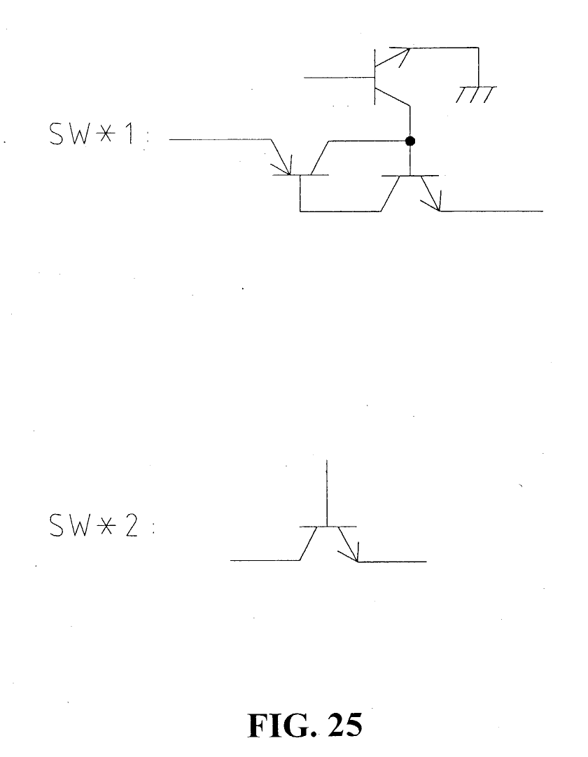

As shown in FIG. 24, the present invention can be extended to environment with a plurality of EL and independent control criteria is obtained, for instance the back light of handphones, and the block diagram of low voltage DC to high voltage is shown in FIG. 1 and the switching structure is shown in FIG. 25. When SW*1 and SW*2 are reverse direction in conduction and SWC*F is a common point of all signals, then SW11 to SWC1 is either same direction or opposite direction, SW21 to SWC1 is either opposite direction or same direction. Thus SWC1, SWC2, SW11 and SW12 will form into a full bridge switch, i.e., when SWC1 and SW12 are in conduction, SWC2 and SW11 are OFF, on the other hand, when SWC1 and SW12 are OFF, then SWC2 and SW11 are in conduction.

The above alternately repeating, voltage to EL 1 will maintain high voltage. If EL 1 is to be closed, switches of SWC1 and SW11, and SWC2 and SW12 are adjusted to same direction. The above cycle will form a continue high voltage AC signal, as shown in FIG. 10. Based on the above method, multiple EL and independent control with low noise can be obtained.

It will be understood that each of the elements described above, or two or more together may also find a useful application in other types of methods differing from the type described above.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A circuit for conversion of DC to AC with voltage elevation and noise reduction comprising transistors, sensors, capacitors connected in series to form a low voltage elevated to high voltage portion, and a plurality of transistors and capacitors to form AC electronic switching portion, characterized in that signals controlling action of the transistors are upgraded from low potential to high potential to speed out the action of the transistor, and at cut off, the signal is formed into negative level configuration, or higher than the positive potential level configuration for circuit action, thereby effective signals on the load is obtained.

2. The circuit of claim 1, wherein a plurality of diodes are used to replace the electronic switching portions to produce in sequence high voltage at the two ends of capacitance load, forming a high voltage AC signal.

3. The circuit of claim 1, wherein capacitors and transistors are incorporated to the circuit to change the output wave form of the control signal, lowering noise generated in the course of DC to AC conversion.

4. The circuit of claim 1, wherein fixed current of the circuit is controlled so as to control the current releasing time so as to lower the noise generated in the course of DC to AC conversion.

5. The circuit of claim 1, wherein at period between the voltage elevation to the end of the voltage elevation, the control signal frequency width is changed so as to increase the smoothness of output wave form.

6. The circuit of claim 1, wherein the circuit is incorporated with a full bridge switch to maintain high voltage AC to independently control a plurality of EL so as to lower noise generated in the course of DC to AC.
